(19) United States
(12) Patent Application Publication
(10) Pub. No.: US 2005/0174737 A1
(43) Pub. Date: Aug. 11, 2005

(54) Quiet cooling system for a computer

(76) Inventor: Ronen Meir, Ashkelon (IL)

Correspondence Address: DENNISON, SCHULTZ, DOUGHERTY & MACDONALD, 1727 KING STREET, SUITE 105, ALEXANDRIA, VA, 22314, US

(21) Appl. No.: 10/498,990

(22) PCT Filed: Dec. 29, 2002
(86) PCT No.: PCT/IL02/01052

(30) Foreign Application Priority Data
Dec. 30, 2001 (IL) 147394

(51) Int. Cl. H05K 7/20

(52) U.S. Cl. 361/697

(57) ABSTRACT

A system for cooling a CPU of a computer within a computer case, the system being characterized by having low noise emission levels, the system comprising: a CPU-cooling unit including a thermoelectric component (TEC) couplable to mains for power supply; a cold side heat sink coupled to the TEC and in thermally conductive contact with the CPU; a hot side heat sink coupled to the TEC; a CPU fan attached to the hot side heat sink for pulling heated air from the hot side heat sink; and an electronic controller, a CPU temperature sensor coupled to the cold plate and to the electronic controller for sensing the temperature of the CPU and providing an indication thereof to the electronic controller; wherein the electronic controller is controllingly coupled to the CPU fan for varying fan speed in accordance with the sensed CPU temperature and with software algorithms.

### FIELD OF THE INVENTION

The present invention relates to the cooling of processors in computers, including but not restricted to Central Processor Units (CPU), and particularly to a method and apparatus for cooling processors in computers, that are characterized by having reduced noise emission levels compared to the cooling systems of the prior art.

### BACKGROUND OF THE INVENTION

There is an increasing awareness that, for the comfort and well being of employees, the background noise levels in the work environment should be kept to a minimum, and it has been reported that excessive noise can have a serious adverse affect on office output levels.

Both users and manufacturers of personal computers (henceforth, PCs) are becoming increasingly aware that the acoustic noise emitted by PCs can be very disturbing. For example, in computer rooms and other work areas with large concentrations of computers, the noise level can reach 40 to 60 dB, which is similar to the noise levels near a busy highway. This can have serious detrimental effects on performance and productivity.

During operation, the processors of PCs generate heat which must be removed to prevent the processor from overheating, and to remove this heat, a cooling system is required. However, conventional cooling solutions, based on fans and heat sinks, are a major source of audible noise; the case fans and the processor fan being especially noisy. Since processors used in state-of-the art PCs operate at ever increasing switching frequencies and processing power, ever increasing amounts of heat are generated; the dissipation of which requires more powerful and faster fans, producing ever higher levels of noise pollution.

Fans operating at lower speeds operate more quietly. However, in conventional systems, there is no way to reduce the fan speed without the processor temperature rising, thus there is always a tradeoff between cooling power and noise.

To reduce noise pollution from PCs, it has been suggested to provide a temperature sensor to continuously monitor the temperature inside the computer case (enclosure) and to continuously change the fan speed accordingly. Such arrangements do not vary the fan speed directly with the temperature fluctuations of the processor however, but only relative to the temperature inside the computer case. Since the temperature of the air in the computer case changes more slowly than the temperature of the processor itself, such arrangements take time to react to changes in processor temperature, and cooling typically begins long after the processor has heated up. This can lead to the processor overheating and result in damage thereto.

Apart from audible noise pollution, another problem associated with computer processing is electromagnetic radiation therefrom. Computer processors generate electromagnetic radiation (EMR), which can cause electromagnetic interference (EMI). The frequency of this radiation increases with the clock speed of processors. The conventional heat sink that is widely used for drawing heat away from the processor generally has cooling fins. Consequently, it often acts as an antenna, effectively transmitting EMR from the processor, and potentially causing interference to the smooth operation of nearby equipment.

In summary, to keep temperatures low enough for efficient processing using a conventional fan and heat-sink solution, the air flow from the fan, and consequently, the fan speed, must be kept high, resulting in unwanted noise emissions. Thus conventional cooling systems including fans are noisy and there is a need to provide a cooling system that is reliable yet quieter in operation. The present invention is directed to providing such a system.

### SUMMARY OF THE INVENTION

It is an aim of the present invention to provide a cooling system for processors in PCs that is quiet in operation.

It is a further aim the present invention to provide a cooling system for processors in PCs that keeps the amount of electromagnetic radiation from the processor within acceptable limits.

It is yet a further aim the present invention to provide a cooling system that has a large cooling capacity for its size.

In a first aspect, the present invention is directed to providing a quiet cooling system for cooling a computer processor, the system comprising:

a processor cooling unit including:
(i) a thermoelectric component (TEC) couplable to a mains power supply;
(ii) a cold side heat sink coupled to the TEC and in thermally conductive contact with the computer processor;
(iii) a hot side heat sink coupled to the TEC;
(iv) a computer processor fan attached to the hot side heat sink for forced convection cooling of the hot side heat sink; and
(v) an electronic controller, for controlling the functioning of the active CPU-cooling unit;
(vi) a processor temperature sensor coupled to said cold plate and to said electronic controller for sensing the temperature of the processor and for providing an indication thereof to the electronic controller;

wherein said electronic controller is controllingly coupled to said computer processor fan for varying fan speed in accordance with said sensed computer processor temperature and software algorithms.

Typically, the computer processor is a central processing unit (CPU), and the electronic controller includes a microprocessor. The system is particularly appropriate for installing in PC type computers.

Generally, the computer also includes at least one case fan mounted in the computer case, and the system further comprises a computer case temperature sensor connected to the electronic controller for sensing the ambient temperature inside the case and providing an indication thereof to the electronic controller, specifically, to the microprocessor thereof, wherein the electronic controller is controllingly coupled to the computer processor cooling fan and to the case fan, for varying fan speeds thereof, in accordance with the sensed processor temperature and the sensed ambient temperature, resulting in the reduction of fan noise.

Preferably, the cold side heat sink includes a grounded, fin-less plate, for reducing Electro-Magnetic Radiation (EMR), and most preferably, the TEC element is also grounded, further reducing EMR.

Optionally and preferably, the system flirter comprises a pulse generator and a take-over mechanism for simulating correct operation of the fan to the motherboard of the computer, even when the fan is actually stopped or is operating at a lowered speed under the control of the electronic controller and in accordance with software parameters such as low ambient temperature and/or low processor load. The pulse generator simulates proper operation of the processor cooling fan to the motherboard, preventing operation of error alarms when the system of the invention initiates reduced speed or fan stop.

Optionally, the system further comprises a reset protection mechanism for resetting the computer if operated in the absence of power to the active CPU-cooling unit. The reset protection mechanism may operate via PCI pins of the computer, for example.

Optionally, the system further comprises a high power PS (power supply) for powering the active CPU-cooling unit. The high power PS is directly powered by the mains, independently of the internal PS of the computer.

Optionally, the power supply and microprocessor with software are produced on a standard PCI card and mounted in a PCI slot in the computer case. Alternatively however, other form factors may be used. For example, source power may be accepted from the computer power supply as shown in FIGS. 2-4 of PCT/IL02/00960 to the same inventor and applicant.

In embodiments having the form factor of a standard PCI card mounted in a PCI slot, the system preferably includes a metal bracket for mounting the card in the PCI slot. Such a bracket typically includes a connector for providing mains power to the PS via the PCI slot of the PC. Optionally, the power supply is a low profile inverter including a planar transformer, which allows the PCI card to occupy only one PC slot. The system may further comprise a card fan mounted on the PCI card for cooling the card. Preferably, power for the CPU cooling fan, the computer case fan and for the controller's microprocessor is drawn via the PCI slot.

The system may also include a temperature sensor located on the PCI card, for sensing the ambient temperature within the computer case.

In another embodiment, the power supply and the microprocessor with software are supplied on a card which is mountable into a frame designed to fit into a standard computer port, such as a 5¼″ or 3½″ drive bay, for example.

In yet another alternative configuration, the power supply and the microprocessor with software are mounted within the internal power supply of the computer.

In still yet another alternative configuration, the power supply and the microprocessor with software are mounted on a card which is mountable on the TEC/heat sink assembly.

Optionally and preferably, the system further comprises an indicator, such as a blue LED for providing an indication of operation of the system (blue being related to “cool” from a marketing perspective). Such an indicator may be mounted in any appropriate, visible location, such as on the PCI bracket where applicable, or in the back of the modified/custom PC power supply where included.

In a second aspect, there is provided a method for cooling a processor of a computer (typically the CPU), the method comprising:

mounting a processor-cooling unit within the computer case, the processor-cooling unit including:

a thermoelectric component (TEC) couplable to a mains power supply for receiving power; a cold side heat sink coupled to the TEC and in thermally conductive contact with the processor; a hot side heat sink coupled to the hot side of the TEC; a processor fan located on hot side heat sink, for pulling heated air from the hot side heat sink; an electronic controller, typically including a microprocessor; and a processor temperature sensor coupled to the cold plate;

measuring the processor temperature;

sensing the temperature of the processor and providing aft indication thereof to the (microprocessor of) the electronic controller;

varying the speed of the computer processor fan in accordance with the sensed processor temperature and thus reducing the amount of audio noise emitted from the computer.

Optionally the method further comprises the steps of:

mounting at least one case fan in the computer case;

mounting a computer case temperature sensor inside the computer case;

coupling the computer case temperature sensor to the microprocessor;

sensing the ambient temperature inside the case and providing an indication thereof to the (microprocessor of) the electronic controller; and

varying the speed of the processor fan and the computer case fan in accordance with microprocessor and software control according to the sensed CPU temperature and the sensed ambient temperature, respectively.

Optionally, the step of varying the speed includes the (microprocessor of) the electronic controller providing a pulse width modulation (PWM) signal via transistors to vary the speed with high efficiency PWM driving the transistors. (This prevents overheating of transistors, or the requirement to use bigger driving transistors for driving the fans).

Optionally the method further comprises the steps of:

sensing a sudden change in processor (CPU) temperature (as determined by the microprocessor and software of the electronic controller); and

varying fan speed in accordance with said change in processor temperature so as to maintain high performance cooling.

Optionally, the method further comprises the steps of sampling data from the processor temperature sensor; determining whether the sampled data is within a pre-selected acceptable range; and, if the data is lower than said pre-selected range, providing a PWM (Pulse Width Modulated) signal output from the microprocessor to control power for the thermoelectric element; and reducing the fan voltage from 12V DC to a lower voltage, such as 6V DC (or some other pre set voltage), thereby significantly reducing noise emitted by the computer.

Preferably, the method further comprises the step of operating at least one computer case fan at a substantially lower duty cycle and therefore voltage, thereby reducing fan speed and consequently, noise emission levels still further.

Optionally, the method further comprises the steps of sampling data from the processor temperature sensor; determining whether the sampled data is within a pre-selected acceptable range, and if said data is higher than the pre-selected range, setting a PWM signal output from the microprocessor to maximum (about 100% PWM) to operate the thermoelectric element(s) at maximum power; and operating the processor cooling fan at maximum speed for maximum cooling of the processor.

Optionally, the method includes the step of indicating that the cooling system is operating at maximum cooling power by providing a suitable indicator, such as a visible indicator.

Alternatively, the method further comprises the steps of sampling data from the processor temperature sensor; determining whether the sampled data is within a pre-selected acceptable range; and, if said data is within said pre-selected range, changing PWM output according to the difference between the sampled data and the lower threshold value, so as to power the TEC element according to the sampling data such that, if the computer processor temperature rises, the PWM is increased, giving more cooling power, reducing the processor temperature, and maintaining a stable processor temperature; and vice versa; however, if the computer processor temperature lowers, the PWM is decreased, giving less cooling power, raising the processor temperature, and maintaining a stable processor temperature.

The computer case fans may be operated at an intermediate voltage and speed, such as at a voltage correlating to about 66% duty cycle (supply about 8V out of 12V, but other voltages can be set), thereby reducing noise while providing cooling.

Optionally, the method further comprises periodically checking for sharp increases in temperature (dT/dt); and, if the current temperature is at least some predetermined value, say about 2° C. (or other value), higher than the temperature previously sampled, setting the PWM signal output from said microprocessor to maximum (100% PWM) to operate said thermoelectric element at maximum power; and operating the processor fan at maximum speed for maximum cooling with fast reaction time to prevent sharp increase in processor temperature.

Optionally the computer case fan is operated at about 66% of duty cycle.

Alternatively, the step of periodically checking includes sampling the cold plate temperature every clock cycle, buffering and comparing the sample to the value sampled at an arbitrary earlier time, such as ten seconds earlier.

Optionally the system provides a lower processor temperature in typical/sleep/idle mode for a higher margin of temperature with low noise from fans, without degrading cooling performance.

Optionally, the microprocessor prevents condensation by maintaining processor temperature above the dew-point.

Optionally, the microprocessor controls the processor temperature to consume very low energy in sleep/idle/typical mode of the processor.

Optionally, in sleep/idle/typical mode of the processor, the fan speed is lowered, thereby reducing undesirable fan vibrations from the fan to the processor.

Optionally the system provides control of a duct fan as that disclosed in Israel Application No. 143786, that operates at a preset value of high ambient inner computer case temperature to further cool the computer case in extreme heat conditions and to reduce/cancel duct fan noise below this preset threshold (such as 40° Centigrade, for example).

### BRIEF DESCRIPTION OF THE DRAWINGS

The present invention will be further understood and appreciated from the following detailed description taken in conjunction with the drawings in which:

FIG. 1 is a functional block diagram showing an active cooling system without the inventive feature of the present invention;

FIG. 2 is a functional block diagram showing an active cooling system featuring electronic control of the operation of the processor cooling fan in accordance with the present invention;

FIG. 3 is a partially open isometric projection of a computer including the active cooling system in PCI card form factor, showing the connections of the PCI card to the fans and to the TEC unit;

FIG. 4 is a side view of the cooling system of FIG. 3, connected to a motherboard, TEC, power cord, and fans;

FIG. 5 shows an active cooling unit with the thermoelectric unit between the hot-side heat sink with fan, and the cold plate attached to the computer processor, and point of ground connection for reducing EMI;

FIG. 6 is a block diagram showing how part circuit diagrams shown in FIGS. 6(I), 6(II) and 6(III) fit together.

FIGS. 6(I), 6(II) and 6(III) are part circuit diagrams of a control circuit showing the connections between the microprocessor, drivers, connectors, reset circuit, and fan take-over circuits, according to an exemplary embodiment of the invention;

FIG. 7 is a block diagram showing how part circuit diagrams shown in FIGS. 7(I) and 7(II) fit together.

FIGS. 7(I) and 7(II) are part circuit diagrams of the controlled switch-mode power supply with connections to the TEC (J3) and to the mains power, according to an exemplary embodiment of the invention;

FIG. 8 is a flow chart of the microprocessor software control, including PWM (Pulse Width Modulation) control of the fans; and

FIG. 9 is a continuation of FIG. 8 above.

### DETAILED DESCRIPTION OF THE INVENTION

The present invention is directed to providing a device and method for the active cooling of a computer microprocessor. It is particularly appropriate for the active cooling of the CPU, and the rest of the description will refer to the cooling of a CPU by way non-limiting example only. In preferred embodiments it simultaneously keeps the CPU temperature acceptably low, minimizes noise pollution (as is typically associated with prior art cooling solutions having large cooling fans) and also minimizes the electromagnetic radiation from the CPU.

The embodiments of the present invention described hereinbelow, are directed to providing a cooling system for cooling the CPU of a computer, the system includes a TEC and a cooling fan directed on the cold side of the TEC. Also included is an electronic controller, typically including a microprocessor, and a power inverter. The system provides high efficiency cooling by applying appropriate voltages to the TEC elements, and prevents condensation under all CPU loads. A further component of the embodiments is a CPU temperature sensor located on the cold plate of the TEC, providing feedback to the electronic controller and enhancing temperature control thereby. The electronic controller is programmed to detect rapid changes in CPU temperature, allowing the prediction of heavy processor loads and the triggering of maximum cooling when this occurs, by increasing the fan speed of the cooling fan. In this manner, fast reaction to changing CPU temperatures is achieved, and high levels of cooling are provided when necessary.

In contradistinction to other systems for cooling CPUs that include TECs, as described in previous patent applications by the applicants hereof, the cooling fan directed onto the TEC is controlled by an electronic controller, typically including a microprocessor. The electronic controller that is also coupled to a temperature sensor situated on the CPU or on the cold plate of the TEC (which is in thermal contact therewith). In this manner, the operation of the cooling fan may be controlled in response to temperature fluctuations in the CPU s relayed by signals from the temperature sensor. By slowing or stopping the cooling fan when not required, average noise emission levels from the computer are minimized. The cooling system of the invention is preferably mounted within the computer case, and several configurations for the powering of the active cooling system and the layout of its critical elements, (henceforth, form factors) are elaborated hereinbelow.

In one form factor, The TECs may be powered by an independent power supply and controlled using a PCI card. Such a form factor was generally described in previous Israel Application No. 136275 (PCT/IL01/00462), but the inventive feature of controlling the fan speed of the cooling fan in accordance with the temperature fluctuation of the CPU, was not discussed therein.

In another form factor, as generally described in Israel Application No. 146838 (PCT/IL02/00960), the TEC may be powered by a standard PC power supply having a large power rating, and controlled by a PCI card. However, the inventive feature of controlling the fan speed of the cooling fan in accordance with the temperature fluctuation of the CPU was not discussed therein.

The invention provides active cooling by using a TEC that is controlled by a dedicated electronic controller, typically including a microprocessor, which receives input from a temperature sensor located on the cold plate of the TEC which reports the rate of change in temperature of the computer processor to the dedicated electronic controller. Optionally, additional temperature sensors, for indicating the ambient temperature within the computer case, for example, are coupled to the dedicated microprocessor. Having received temperature input signals, the electronic controller controls the power supply of the TEC attached to the CPU, and. In this manner, the controlled power supply supplies the correct amount of power to the TEC, varying its cooling ability with the changing CPU loads.

The control loop of the system of the invention is capable of reacting to sudden rapid rises in temperature of the CPU, faster than conventional passive solutions can. Such sudden rises in CPU temperature reflect increased processing loads. (Sudden, large temperature changes are becoming more frequent, and present a growing problem since the gap between typical and maximum processing power of CPUs is increasing as new and more powerful processors are developed).

When CPU power consumption is low however, (such as in sleep, idle, or typical mode), the microprocessor provides the TEC with reduced power and decreases the thermoelectric hot-side heat-sink fan speed. This significantly reduces noise emission. (Although the reduction in the fan speed will invariably result in the hot-side heat sink increasing in temperature, since the computer processor is attached to the cold side heat sink, it is separated from the hot side heat sink by the Tec and by the Cold side heat sink, and thus does not become hotter, and the performance of the active cooling system is maintained while fan noise emission levels are kept low.

In preferred embodiments, an ambient temperature sensor for monitoring the temperature within the computer case is provided, and this, together with the computer case fans are connected to the electronic controller. In this way, the speed of the computer case fans may be controlled according to the ambient temperature inside the computer case, further reducing noise emission.

Another feature of the present invention is that the thermoelectric Paltier element(s) TECs are connected to the CPUs via cold plates which are preferably solid castings without fins or protrusions, and are preferably fully grounded. Consequently, these cold plates do not generally act as antennae for radiating EMR from the processor, and the amount of EMR emitted by the computer is thus significantly reduced. Furthermore, the thermoelectric elements are preferably also grounded, supplying a second layer of grounding that generally reduces EMR still further.

The cooling system of the present invention may be actualized in various embodiments or “form factors”, four of which are briefly described below:

(a) In a first embodiment of the present invention, the form factor is in the configuration of a card for driving the TEC, which is mountable inside the PC power supply, minorly modifying the PC power supply.

(b) In a second embodiment of the present invention, the form factor is in the configuration of a card for driving the TEC, produced on a standard PCI card and mountable in a PCI slot.

(c) In a third embodiment of the present invention, the form factor is in the configuration of a card for driving the TEC, which is mountable in a frame that fits into a bay, such as a standard 5¼″ or 3½ drive bay.

(d) In a fourth embodiment of the present invention, the form factor is in the configuration of a card for driving the TEC, which may be mounted on the TEC/heat sink assembly.

Fore more information regarding these configurations (without mention of the fan control feature of the present invention), see IL 146838 (PCT/IL02/00960).

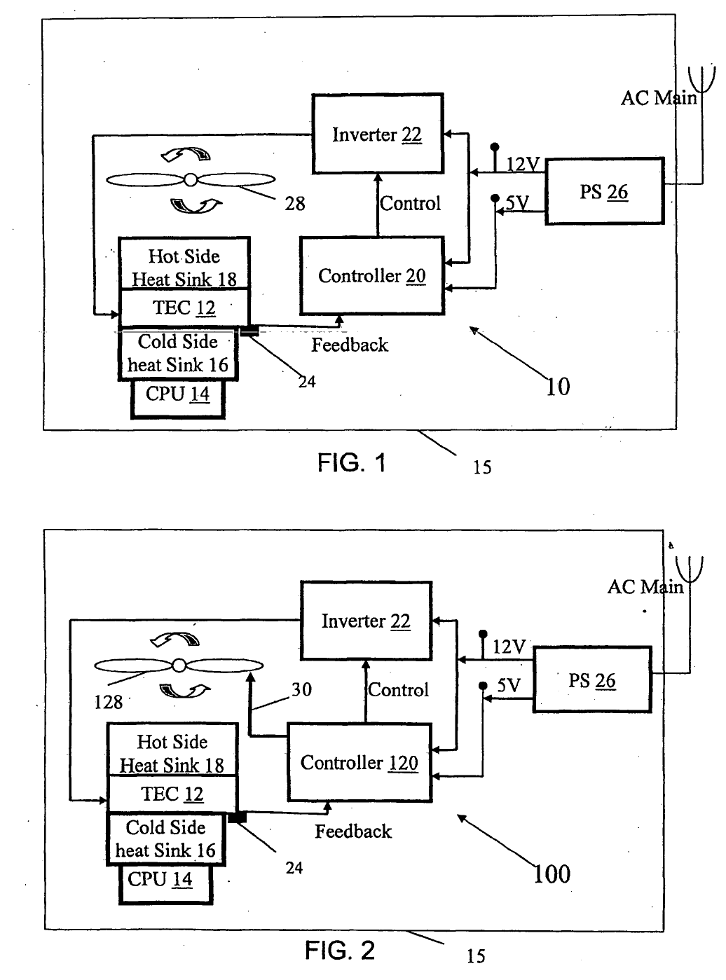

Referring to FIG. 1, a generalized cooling system 10 for a computer 15, as disclosed in PCT/IL02/00960, a copending application by the present applicants and inventor, that uses a TEC 12 to cool a computer processor, shown herein as being as a CPU 14, is shown. The cooling system 10 consists of a cold side heat sink 16, otherwise known as a cold plate, which is adjoined to the CPU 14. Coupled to the cold side heat sink 16 there is at least one TEC 12, to which is coupled a hot side heat sink 18. An electronic controller 20 and inverter 22 are provided for controlling the functioning of the TEC 12 by varying the power supplied thereto in response to temperature readings from a temperature sensor 24 which provides signals to the controller 20, corresponding to the temperature of the cold side heat sink 16, and thus of the CPU 14 with which it is in thermal contact. The controller 20 and inverter 22 receive their power from a Power Supply (PS) 26, which typically is connected to the mains. Also shown in FIG. 1, is a cooling fan 28 directed onto the hot side heat sink 18 for forced convection cooling thereof. A cooling fan of this type, operating in conjunction with heat sinks, and generally powered by the PS of the computer, is a common element found in most computer cooling systems.

The cooling system 10 shown prevents the CPU 14 from over-heating by controlling the power supplied to the TEC 12 in response to changes in temperature of the CPU 14. Preferably, the controller 20 is programmed to detect rapid changes in the temperature of the CPU 14, allowing the cooling system 10 to predict heavy processor load and to trigger maximum cooling before temperatures reach unacceptable levels. By having electronic controller 20 for the TEC 12 responding to real-time temperature fluctuations of the CPU 14 as determined using the temperature sensor 24, highly efficient cooling is provided to the CPU 14. An additional advantage of this arrangement is that condensation is prevented at all CPU loads. Furthermore, in contradistinction to conventional fan-heat sink solutions, the cooling system 10 can cool the CPU 14 to below the ambient surrounding temperature.

The present invention is directed to providing an improvement to the controlled TEC cooling system described with reference to FIG. 1 hereinabove. The improvement allows for the controlled reduction in the fan speed of the CPU cooling fan 28, providing thereby a significant reduction in the acoustic noise emission from the computer 15.

Referring now to FIG. 2, there is shown a generalized improved cooling system 100 of the present invention, being an improvement of the generalized cooling system 10 (FIG. 1) as disclosed in PCT/IL02/00960, a copending application by the present applicants and inventor, that uses a TEC 12 to cool a processor, such as a CPU 14, is shown. The improved cooling system 100 consists of a cold side heat sink 16, adjoined to the CPU 14, coupled to which there is at least one TEC 12, to which is coupled a hot side heat sink 18. Also provided are an electronic controller 120 and inverter 22, for controlling the functioning of the TEC 12 by varying the power supplied thereto in response to temperature readings from a temperature sensor 24 which provides signals to the electronic controller 120, corresponding to the temperature of the cold side heat sink 16, and thus of the CPU 14. The electronic controller 120 and inverter 22 receiving their power from a Power Supply (PS) 26, typically connected to the mains, as shown in the generalized system of FIG. 1 mutatis mutandis. In contradistinction to the cooling system 10 of FIG. 1 however, in the improved cooling system 100 of FIG. 2, the cooling fan 128 is controllingly coupled to the controller 120 (by control lead 30), which includes a processor, typically a microprocessor, which, in addition to controlling the functioning of the TEC in response to the signals from the temperature sensor 24, also varies the speed of the fan 128 in response to the temperature signals received from the temperature sensor 24 and in accordance with appropriate software algorithms.

In this manner, by allowing the reducing of the fan speed to the minimum required, the present invention provides a system having lower noise emission levels than passive fan and heat sink solutions, whilst also providing improved cooling of the processor. It is however, able to react quickly to CPU temperature changes, preventing overheating thereof.

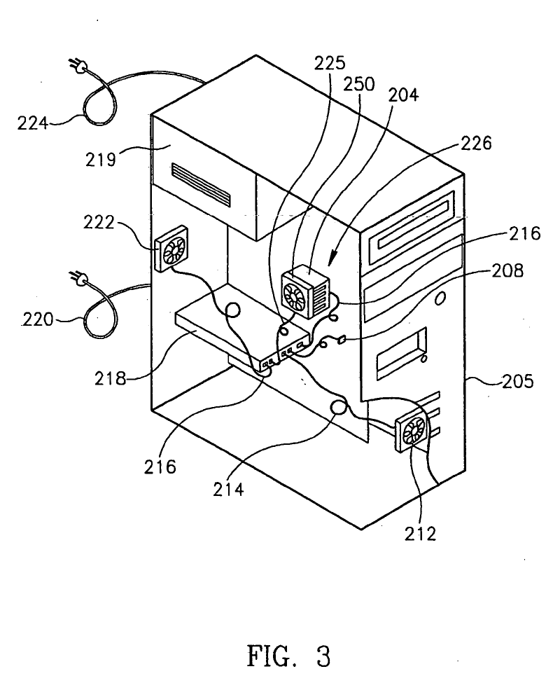

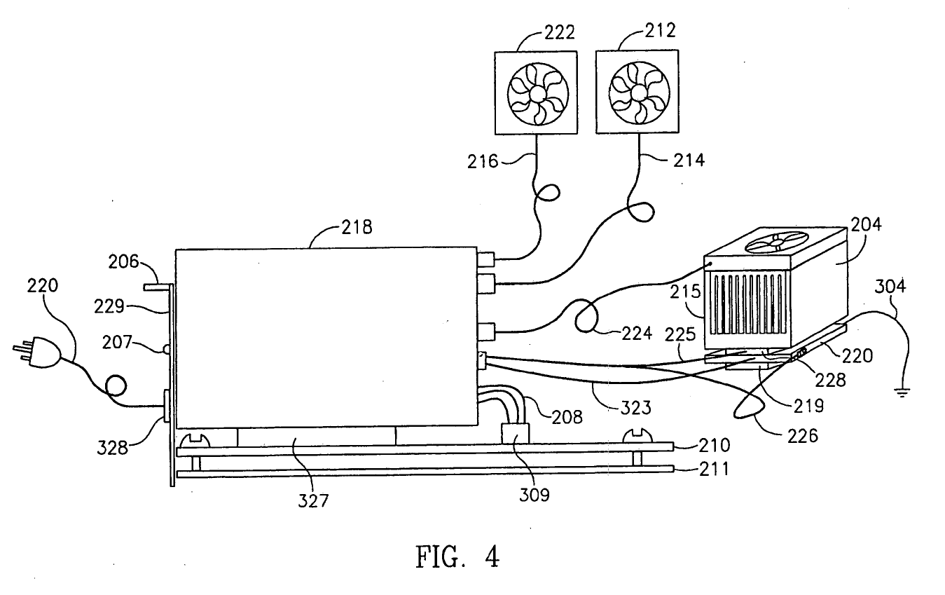

Referring now to FIGS. 3 and 4, there is shown a first specific embodiment of a cooling system 200 for a CPU mounted in a computer case 205, in accordance with the present invention. The cooling system 200 consists of a PCI active cooling control card 218 that includes a thermoelectric unit 226 that is attached to the computer processor (not shown), mounted in the computer case 210.

AC power cord 220 connects the PCI card 218 to the mains, via the PCI bracket 206 in the back of the computer, and provides power to the active cooling system. Accordingly, the PCI card 218 is connected to the thermoelectric element (TEC) 226 via a connecting lead 216. The connecting lead 216, in addition to providing power to the TEC 226, also carries signals from a CPU temperature sensor connected to the cold plate 20 of the TEC 226, to the PCI card 218.

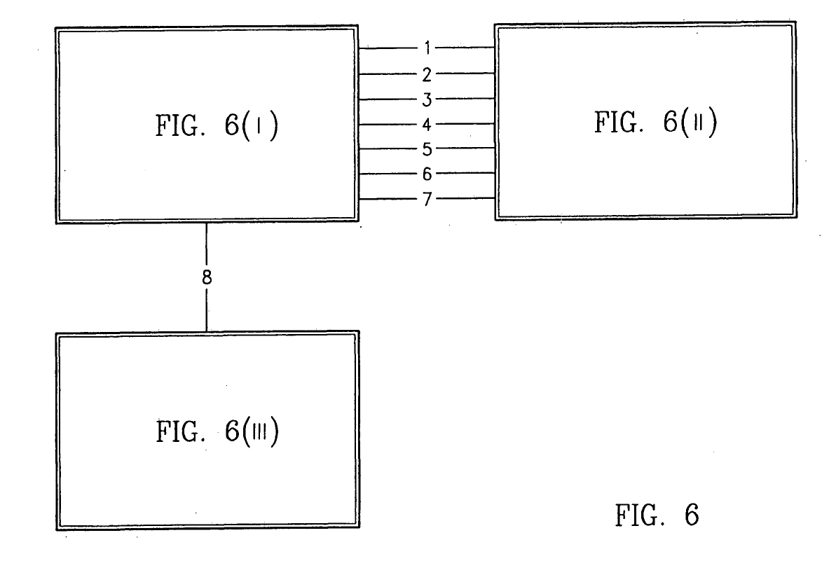

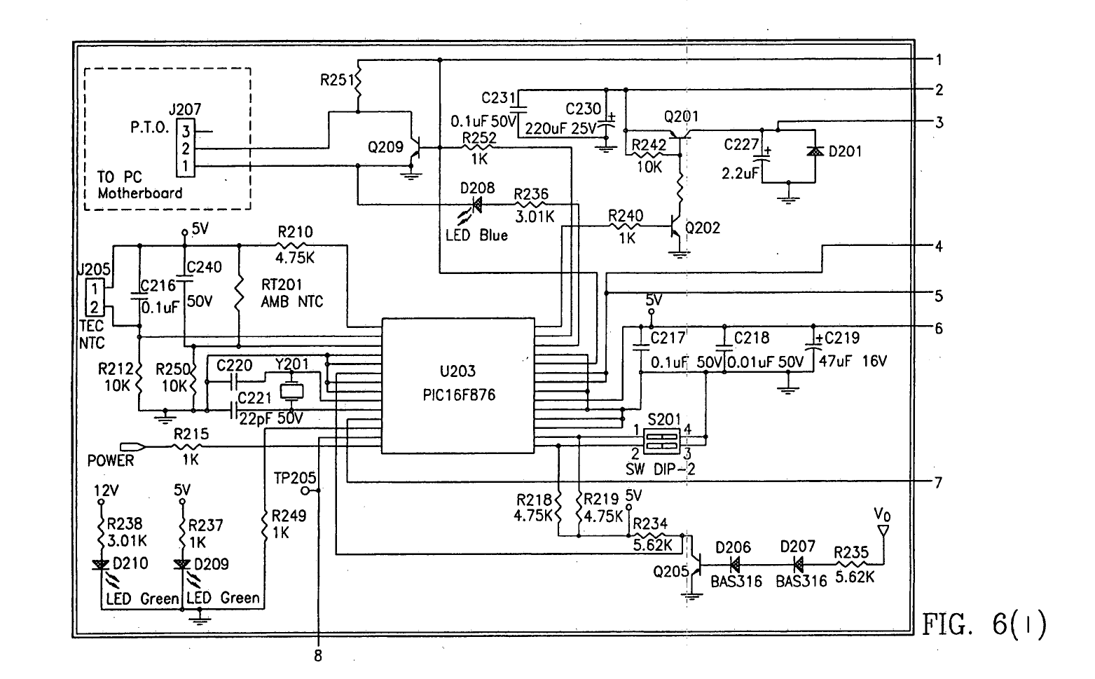

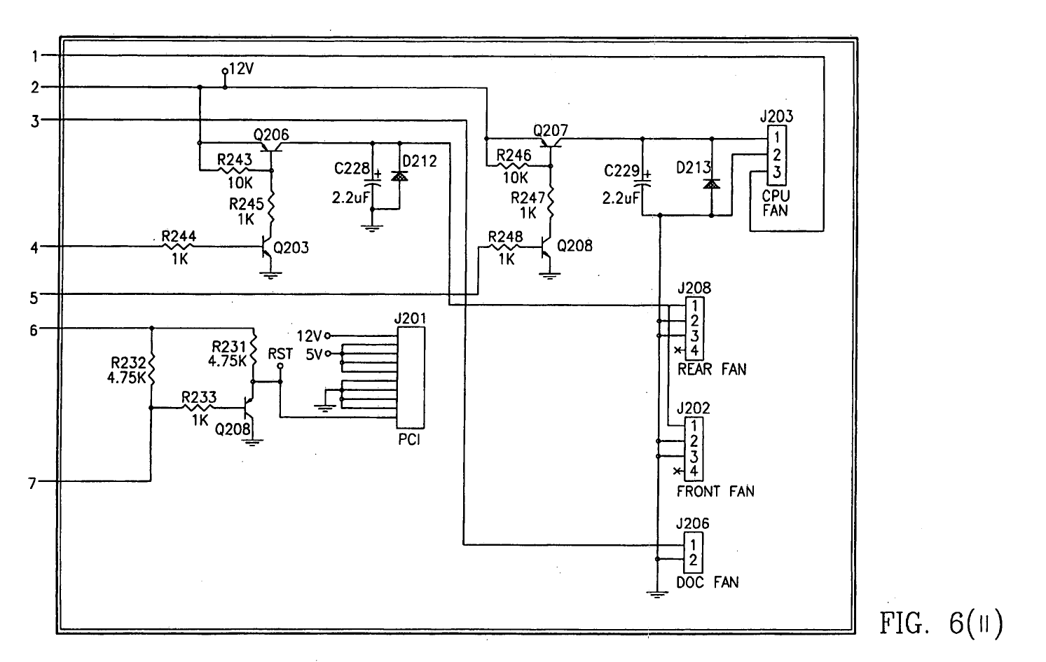

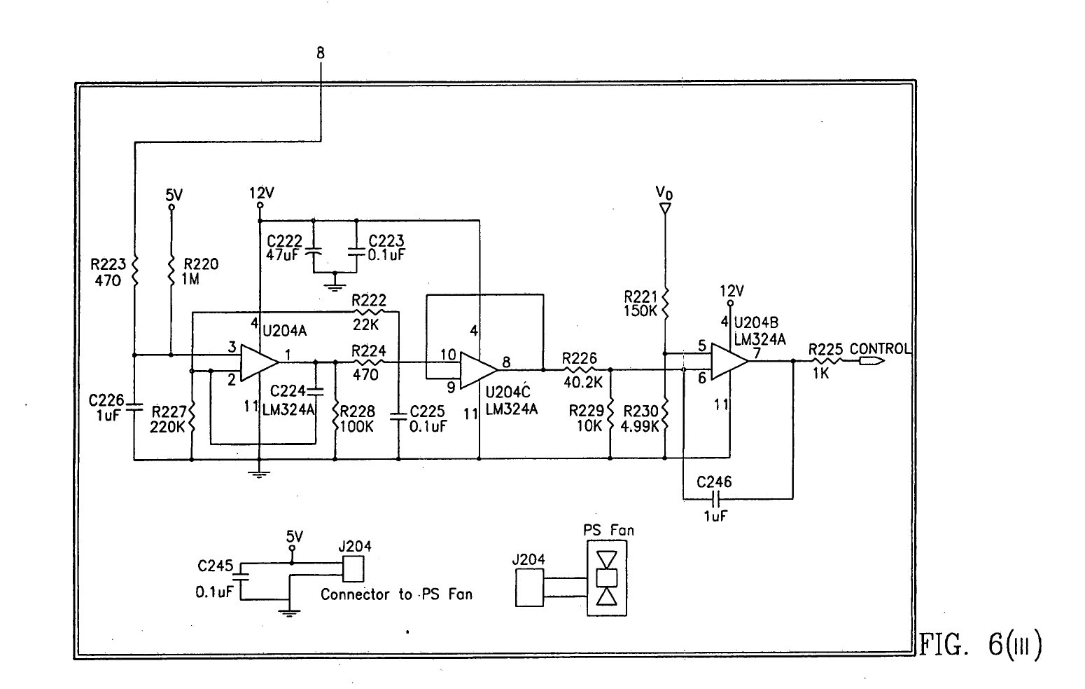

The thermoelectric hot-side heat-sink 204 is connected to the PCI card 218 via a connecting wire 225. Case fans 222, 212 which cool the interior of the computer case, are connected to the PCI card 218 via connecting wires 216, 214. An additional wire 208 connects the PCI card to the motherboard. A schematic of one appropriate connector, in accordance with a preferred embodiment, is shown as Part J207 in FIG. 6(I). The connector of the preferred embodiment provides pulses to the fan connection of the motherboard to simulate fan operation when fan operation is stopped at the initiative of the microprocessor (FIG. 6(I) Part U203), as described in detail below. It will be noted that in this embodiment, the PCI card 218 is directly connected to the mains via AC power cord 220, and does not draw power from the power supply of the computer 219, which has its own power cord 224.

Still referring to FIGS. 4, there is shown, in more detailed schematic view, portions of the CPU-cooling system 200 of one embodiment of the present invention coupled to a CPU 219 to be cooled. The CPU cooling system 200 includes a TEC element 226 coupled to a hot side heat sink 204, having an associated CPU fan 250 directed to providing convection cooling thereto. The TEC element 226 is also coupled to a cold side heat sink 220, which is coupled to the CPU 219. It is a particular feature of the invention that the cold side heat sink 220 is preferably a fin-less heat sink, and is grounded, as by a wire 304. Having a grounded, finless structure, the heat sink substantially lowers the electromagnetic radiation from processors cooled using the system, and helps enable Electro Magnetic Compatibility (EMC) guidelines to be achieved. TEC element 226, above cold plate 220 is also directly grounded, providing improved grounding for increased EMC. The power supplied to the CPU fan 250 is controlled by setting the voltage applied thereacross over a preset range, typically 6-12 V. on the PCI card (FIG. 6, J203) via a connector, which is controlled by the electronic controller, typically including a microprocessor. Thus, power is provided to the CPU fan 250 from the cooling system, rather than from the motherboard, as in conventional passive cooling systems.

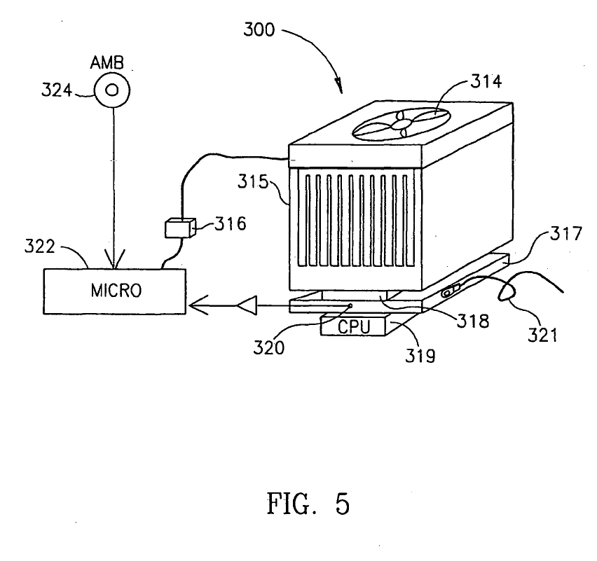

Referring to FIG. 5, there is shown a cooling unit 300 consisting of a cold plate 317 coupled to a TEC 218, to which is connected a hot side cooling plate 315, convection cooled by a cooling fan 314. The cooling unit 300 is coupled to a computer processor, shown herein as a being a CPU 319. The cold plate 317 is grounded by a grounding lead 321 which may be connected to the motherboard or to the casing of the computer, for example.

A CPU temperature sensor 320 is mounted on the cold plate (cold side heat sink) 317 and coupled to the cooling system's electronic controller 322. An ambient temperature sensor 324, also coupled to microprocessor 322, may also be provided within the computer case. In this way, microprocessor 322 can control both TEC 318 operation and fan 314 operation in accordance with the temperatures of the CPU 309 and the ambient temperature within the case, as sampled by the sensors 320, 324.

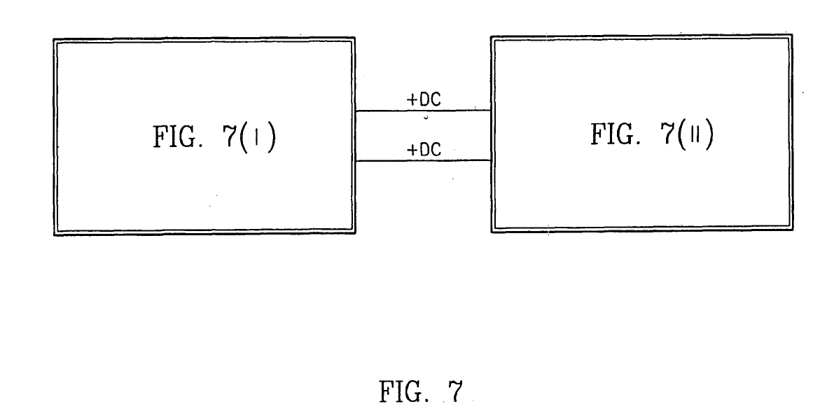

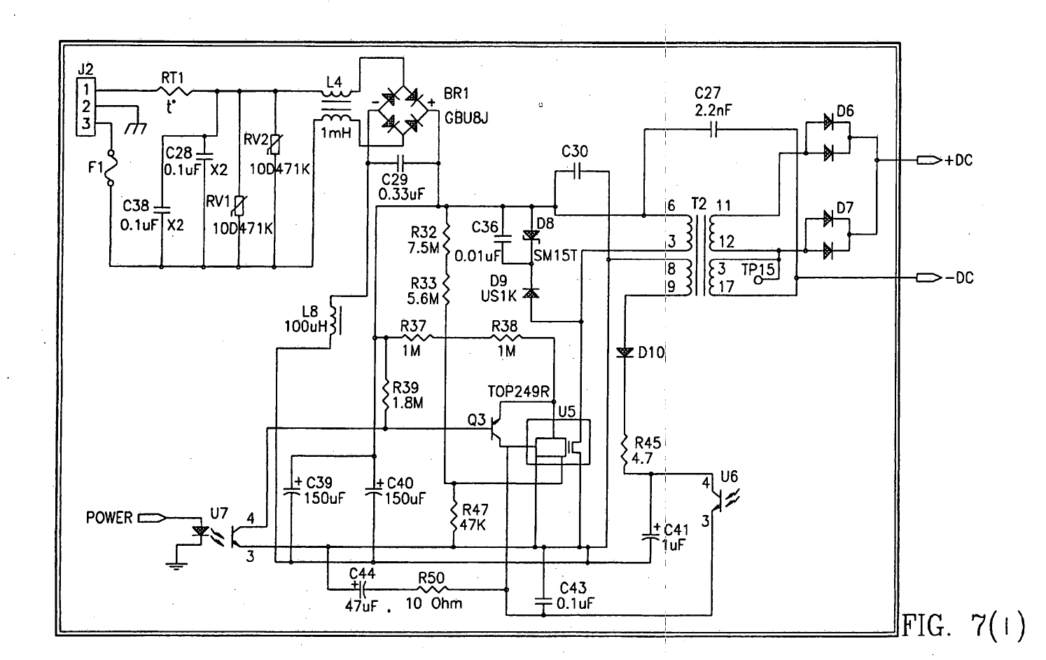

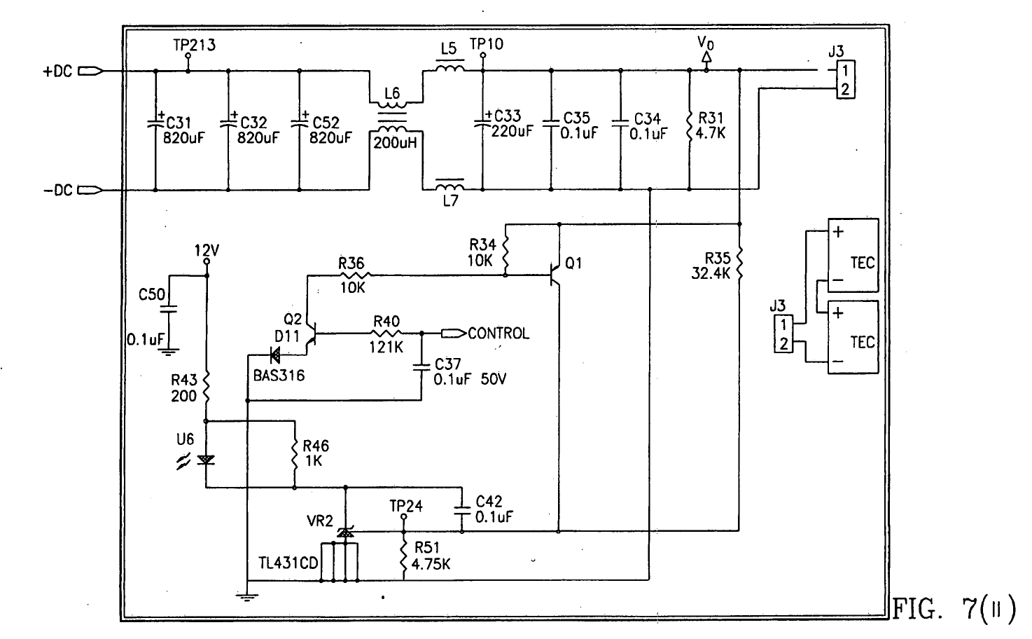

Referring back to FIG. 4 there is shown a side view of a PCI card 218 of an active cooling system according to another embodiment of the invention. The PCI card 218 contains control circuits, an example of which is shown schematically in FIG. 6, and a power inverter, an example of which is shown schematically in FIG. 7. As can be seen in FIG. 4, PCI card 218 mounted in a PCI slot 327 of the computer case. According to a preferred embodiment, the power inverter includes a planar transformer of relatively low thickness, thereby permitting the entire cooling system to fit into a single, conventional PCI slot. The PCI card 218 receives mains power from a power cord 220, fed via a bracket 206 to the PCI card power connector 328. In this way, the PCI card 218 receives power independently of the PC power supply, which is a particular feature of all preferred embodiments of the present invention. This serves as an added safety feature, in that the computer cannot be turned on unless the cooling system has been activated previously. This is explained in greater detail hereinbelow.

The PCI card 218 has output connectors that supply power to the TEC 228 via a wire 216. The cold plate 220 may be grounded via the PCI card 218, reducing EMI emission from the computer processor 319 thereby. A CPU temperature sensor wire 323 carries an input temperature signal from a sensor on the cold plate 220. Also provided, is a connector 309, which provides the fan take-over signal to the motherboard 210, and connecting leads 214, 216 which provide controlled voltage to the front 212 and rear 222 case fans.

The PCI card 218 preferably includes a protection circuit. One example of such a circuit is shown in FIG. 6, where J201 is connected via transistor Q204, receiving reset signals to microprocessor U203, pin 11. This protection circuit prevents the operation of the computer when it is operated without power to the PCI card 218 via the power connector 328, thus preventing operation of the computer without the active cooling system. Should an attempt be made to operate the computer without the power cord 220 of the active cooling system being connected to the mains, the PCI card 218 featuring the protection circuit will send a reset signal through the PCI bus to the motherboard.

The CPU and case fans 250, 212, and 222 (FIG. 4) are powered with 12V DC via the PCI slot 327 of the motherboard 210. The 5V DC required by the control microprocessor (FIG. 6, U203 and other circuits in FIG. 6) is also provided via the PCI slot 327; however, the power drawn from the PCI slot is low.

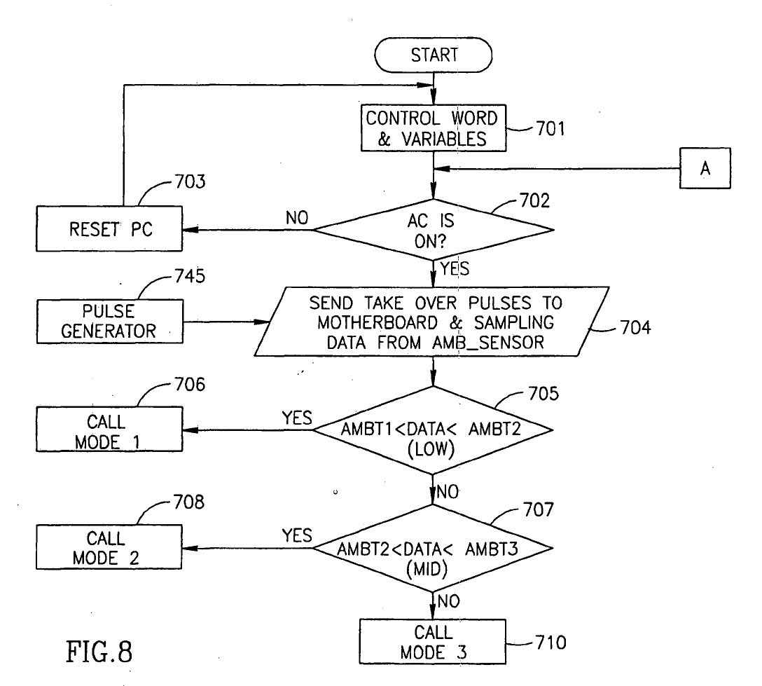

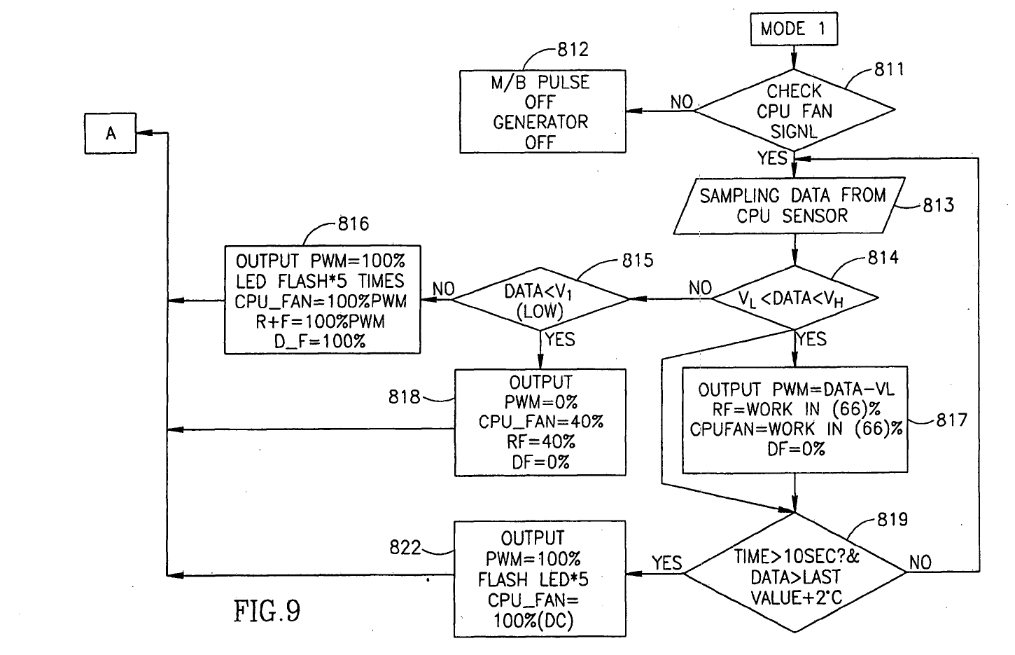

The PCI card 218 shown in FIG. 4 occupies only one PCI slot 327 on the motherboard 210 and has a slim profile. The power inverter of the PCI card 218, as shown in FIG. 7, is preferably a high-efficiency inverter that converts a wide range of AC input voltages (85VAC-260VAC) to low voltage DC, with high power and high efficiency (˜90%) using a switched mode power supply with a low-profile planar transformer (FIG. 7, T2), such as that made by Payton Planar Magnetics. The power supply output voltage to the TEC (FIG. 7, J3) is controlled by the microprocessor (FIG. 6, U203) control signal (right-hand side of FIG. 6, R225). The power, and therefore the control signal, varies according to the software instructions from the microprocessor software, (shown as flowcharts in FIGS. 8 and 9) according to the temperature signals from the sensors (FIG. 6, AMB NTC measuring ambient temperature in the computer case) and (FIG. 6, J206 measuring temperature at the cold plate connected to the PCI Card 218 via a wire 323. An optional connector (FIG. 6, J206) controls extra duct fan(s) when the ambient temperature inside the computer case reaches predetermined threshold, such as one defined in the software of the system.

The PCI card (FIG. 4, 218) receives 5 V DC from the PCI bus and may have a small internal fan (FIG. 6, J204) to remove heat from the PCI card itself connected via the PCI card bracket 206, which has ventilation holes 229 therethrough, to exhaust heat outside the computer cage.

The fans 250, 212, 222 are controlled by microprocessor (FIG. 6, U203) which generates a pulse-width modulated (PWM) signal, which is fed to the driver transistors (FIG. 6, Q209, Q201, Q206, Q207). Pulse width modulation is preferred because with this type of signaling, the driver transistors dissipate less heat when switched, and overheating of the transistors is prevented thereby. This also permits very small transistors to control the fans. The output voltage to the fans is smoothed by capacitors (FIG. 6, C229, C228, C227), depending on the duty cycle of the PWM, controlled by the microprocessor (FIG. 6, U203) according to the algorithms shown schematically in FIGS. 8 and 9).

If the ambient temperature inside the PC case is low and the CPU 219 is in sleep/idle/typical operation mode, the hot-side heat-sink fan 250 can be stopped altogether, silencing it completely. There is no danger in stopping the fan in this manner, because the active cool system will react immediately to remove heat from the processor if there is a sudden change in the operational mode of the processor from sleep/idle/typical mode to heavy loading thereon, or any other cause of a rapid rise in temperature.

Intermittent controlled stopping of the fan in this manner when it is not needed for cooling, significantly reduces audible noise emitted by the computer. The conditions for stopping the fan are controlled by the microprocessor software routines shown in FIGS. 8 and 9.

In conventional systems, the motherboard and fans are built with a fan signal wire that sends pulses to the motherboard to indicate that the fan is operating correctly. If the fan is not operating correctly or is operating below its threshold speed (set by the motherboard software or other control software, such as Intel Active Monitor), an alarm will sound and an alarm message will appear on screen. When the cooling system of the present invention is retrofitted to a conventional motherboard, in order to prevent these alarms when the fan is deliberately stopped or slowed down to reduce noise, microprocessor (FIG. 6, U203) transmits pulses (FIG. 6, pin 27 of U203) (called herein “fan take-over pulses”), mimicking the signal sent by a normally operating fan via a transistor (FIG. 6, Q209) to a connector (FIG. 6, J207), which is connected to the motherboard. Thus, these fan take-over pulses are sent to the motherboard as long as the active cooling system is operating correctly. Should the fan actually fail, the microprocessor software will not send the fan take-over pulse, causing the normal motherboard alarms to be activated.

This lowering of the fan speed of the cooling fan significantly lowers the noise emitted by the fans, and thus of the computer. The heat emitted by the computer processor during sleep/idle/typical operation mode is relatively low, allowing the fans to be slowed, or even stopped. The thermoelectric cooling is operational at these times, and allows the removal of routinely generated heat and reacts quickly to combat rapid temperature rises. It will be appreciated that lowering the fan speed without thermoelectric cooling, using only passive fan and heat-sink cooling as in the prior art, increases the idle temperature of the computer processor, lowers the margin for accommodating hot spots caused by rapid rises in temperature. Thus using passive solutions (fan with heat sink), the tradeoff between noise and cooling power tightly constrain each other, and the proposed invention provides better cooling even at very low fan speed (fan voltage dropped from 12V DC to as low as 6V DC, significantly lowering emitted noise during sleep/idle/typical operation mode, while providing superior cooling performance is physically possible even though the temperature of the hot-side heat sink rises while the fan slows down, because the computer processor is attached to the cold plate, whose temperature is controlled by the thermoelectric unit and the microprocessor/sensor loop according to software instructions (FIGS. 8 and 9), and isolated from the heat sink.

The processor (FIG. 6, U203) operates according to the software control routines shown in FIGS. 8 and 9, which will now be described. The control routine is activated as soon as the computer is turned on and 5V DC is applied via the PCI connector (FIG. 6, J201) to pin 20 in the microprocessor (FIG. 6, U203). Upon initialization of the routine, control word and variables (such as processor details, temperature ranges, heat dissipation target, etc.) are internally defined (701). The microprocessor checks for AC voltage (702) at pin 6 of the microprocessor (FIG. 6, U203). If there is no AC voltage (702), pin 6 (FIG. 6, U203) becomes low and initiates a reset (703) the computer via pin 11 of the microprocessor (FIG. 6, U203) to the PCI connector (FIG. 6, J201), preventing operation of the computer when there is no power to the active cooling system of the present invention.

If there is AC power to the cooling system, take-over pulses generated by the microprocessor pulse generator (745) are sent (704) to the motherboard to prevent alarms that fan is not operating (as described above).

At the same time, the microprocessor samples the ambient temperature sensor data signal (704). Ambient temperature sensor can be in any convenient location in the computer case, such as on the PCI card, on the back wall of the power supply, or near the air intake ventilation hole. FIG. 8 describes three ranges of ambient temperature: (705) is LOW, (707) is MID, and (709) is HIGH. For each range, a different routine is called. If the range of the ambient sensor data values (705) is LOW, then Call Mode 1 (706) is activated. If the range is MID, call mode 2 (708) is activated. If neither of these two modes are activated, call mode 3 (710) is activated, indicating HIGH ambient temperature range. The Call Modes control the power level for the TEC element, case fans, and computer processor fan.

FIG. 9 describes the Call Modes in detail. All Call Modes are identical except for the temperature threshold values. First, the computer processor cooling fan signal (FIG. 6, U203, pin 24) is checked to verify that the fan is functional (811). If the fan is not functional, the fan take-over pulses to the motherboard are switched off (812) and the motherboard will issue the usual warnings for fan failure. In either case, the data from the CPU temperature sensor located on the cold plate is sampled.

If the cold plate temperature is not within the allowed range (814), then control passes to (815), which checks if the data is below the low threshold. If it is below the low threshold, control passes to (818) and the PWM (Pulse Width Modulated) signal output from the microprocessor pin 13 (FIG. 5, U203) is dropped to 0 to turn off the control power for the thermoelectric element; and the hot-side heat-sink fan control signal from pin 22 (FIG. 5, U203) delivers PWM pulses to transistor Q208 at about 40% duty cycle, reducing fan voltage to from 12V DC to 6V DC, thereby significantly reducing noise. In addition, according to one embodiment of the invention, rear and front fans are operated at about 40% duty cycle, reducing speed and emitted noise and the optional duct fan voltage (D_F) is set to about 0% duty cycle (turned off). Then control returns to A, the beginning of the control loop in FIG. 8.

If the cold plate temperature at (814) is not within range and it is not low, then it must be high. Then routine (816) receives control. In routine (816), the PWM signal output from microprocessor pin 13 (FIG. 5, U203) is set to maximum (about 100% PWM) to operate the thermoelectric element(s) at maximum power. A blue LED (FIG. 2, 207), or other indicator located on the PCI card bracket (FIG. 4, 306), flashes 5 times to indicate that cooling is switched to maximum. The hot-side heat sink fan control signal from pin 22 (FIG. 5, U203) delivers PWM pulses to transistor Q208 at about 100% of duty cycle, to operate the fan at maximum speed for maximum cooling. In the case where the rear and front fans of the computer case are controlled by the cooling system microprocessor, these fans are operated at about 100% of duty cycle (816 in FIG. 8, R+F=100%); and the optional duct fan, if connected, is operated at about 100% of duty cycle. Then control returns to point A at the beginning of the control loop in FIG. 8.

If the cold plate temperature at (814) is neither high nor low, then control passes to routine (817). At (817), the PWM output is changed according to the difference between the input data (813) and the lower threshold value V_{L} (814). The PWM output powers the TEC element according to the sampling data (813) such that, if the computer processor temperature rises, the PWM is increased, giving more cooling power, reducing the processor temperature, and maintaining a stable processor temperature, and vice versa In addition, R+F (rear and front computer case fans) are operated at an intermediate voltage and speed, correlating to about 66% duty cycle (correlating to approximately 8V DC applied to each fan), reducing noise while providing cooling. The computer processor cooling fan is also operated at about 66% duty cycle, with the same benefits. The optional duct fan is turned off (D_F=0). Control is passed to routine (20), which saves the last temperature value at the top of the register, and-pushes the oldest value off the bottom of the register. Then control is returned to point A at the start of the control loop in FIG. 8.

In parallel with routine (817), routine (819) checks for sharp increases in temperature (dT/dt). At (819), the cold plate temperature is sampled every clock cycle, buffered and compared to the value sampled ten seconds ago.

If there is a sharp rise in temperature, e.g. the current temperature is 2° C. or more, higher than the temperature sampled ten seconds ago, routine (822) is activated. Otherwise control returns to routine (813) and data is sampled again.

Routine (822) handles sharp rises in temperature. The PWM signal output from microprocessor pin 13 (FIG. 6, U203) is set to maximum (100% PWM to operate the thermoelectric element(s) at maximum power; a blue LED (FIG. 2, 207) or other indicator, located on the PCI card bracket (FIG. 4, 206) flashes 5 times to indicate that cooling is switched to maximum; the hot-side heat sink fan control signal from pin 22 (FIG. 6, U203) delivers PWM pulses to transistor Q208 at about 100% of duty cycle, to operate the fan at 5 maximum speed for maximum cooling; the rear and front fans of the computer case are operated at about 66% of duty cycle (in FIG. 8, (16), R+F=66%); and the optional duct fan, if connected, is off. Then control returns to point A at the beginning of the control loop in FIG. 8.

Thus, the control loop of the present invention provides active cooling, noise control, and processor temperature stabilization, maintaining the processor temperature above the dew-point, under both low load and high load conditions, and responds extremely fast (reaction time is less than about 01.sec, active cooling provided in about 1 second) to processor temperature changes. In addition, the physical layout of the cooling assembly when grounded reduces EMI emission.

### EXAMPLE

By using an active cooling system of the present invention, having a fan operating at a voltage of 6V and a TEC, when the ambient temperature is 30° C., and there being a 20W load on the CPU, the case temperature can be maintained at 27° C., that is, 3° C. below ambient temperature. In contradistinction, the prior art, passive solution of a heat sink, and a similar 6V fan, results in the CPU case temperature stabilizing at 37° C., that is, 10° C. more than that achievable with active cooling. If a higher power TEC is used, even better results are obtainable.

Although the cooling system described herein is particularly appropriate for cooling a CPU, it may also be applied to cool other solid state components.

It will be appreciated that the invention is not limited to what has been described hereinabove merely by way of example. Rather, the invention is limited solely by the claims which follow in which the word “comprise” and variations thereof, such as “comprising”, “comprised” and the like, implies that the explicitly detailed components or steps are included, but not to the exclusion of other components or steps:

1. A cooling system for cooling a processor in a computer housed within a computer case, the system characterized by having a low noise emission level, the system comprising: a processor-cooling unit including a TEC/heat sink assembly which includes: a thermoelectric component (TEC) couplable to mains for power supply; a cold side heat sink coupled to one side of said TEC and mounted to be in thermally conductive contact with the processor; a hot side heat sink coupled to said TEC on opposite side thereof, to the side to which the cold side heat sink is coupled; a processor cooling fan directed onto said hot side heat sink for convection cooling of said hot side heat sink; and an electronic controller; a processor temperature sensor coupled to said cold side heat sink and to said electronic controller, for sensing the temperature of the processor and providing an indication thereof to the electronic controller; wherein said electronic controller is controllingly coupled to said processor cooling fan for varying fan speed thereof, in accordance with said sensed processor temperature and appropriate software.

2. The cooling system according to claim 1, wherein the processor is a Central Processing Unit (CPU), and the computer is a PC.

3. The cooling system according to claim 1, wherein the electronic controller comprises a microprocessor.

4. The cooling system according to claim 1, wherein the computer further includes at least one case fan mounted in the computer case, the system further comprising: a computer case temperature sensor mounted within the computer case and being connectively coupled to the microprocessor for providing an indication of ambient temperature inside the computer case to said electronic controller; Said electronic controller being controllingly coupled to said case fan for varying fan speed thereof, in accordance with said indication from said CPU temperature sensor, and said indication of ambient temperature within case, resulting in further reductions to fan noise.

5. The cooling system according to any claim 1, wherein said cold side heat sink includes a fin-less plate that is grounded, thereby reducing Electro Magnetic Radiation (EMR) emissions from said processor.

6. The cooling system of claim 1, wherein said TEC is grounded, thereby reducing Electro Magnetic Radiation (EMR) emissions from said processor.

7. The cooling system of claim 1, said computer having a mother board, and said system further comprising a pulse generator and a take-over mechanism connectively coupled to said electronic controller for providing a signal to motherboard of said computer; said signal simulating normal functioning of processor cooling fan, even when said processor cooling fan functions abnormally, whilst under control of the electronic controller in accordance with software parameters; said signal preventing operation of an error alarm on the motherboard when system initiates reduced speed or fan stop.

8. The cooling system of claim 1, wherein said electronic control of said cooling system is mounted on a PCI card having pins, and said system further comprises a reset protection mechanism via the PCI pins for resetting the computer if computer is operated without power having been supplied to said cooling system.

9. The cooling system of any of claim 1, further comprising a dedicated power supply for powering said processor-cooling unit that is directly mains powerable, independently of internal power supply of said computer.

10. The cooling system of claim 9, wherein said dedicated power supply, said electronic controller and said software are fabricated as a standard PCI card that is mountable in a PCI slot in the computer case.

11. The cooling system of claim 10, further comprising a metal bracket for mounting said PCI card in said PCI slot; said bracket including a connector for providing mains power to said dedicated power supply via said PCI slot.

12. The system of either of claim 10, said computer having a motherboard, wherein said dedicated power supply includes a low profile inverter having a planar transformer, allowing the PCI card to occupy only one PC slot on said motherboard.

13. The system of claim 10, further comprising a card cooling fan mounted on said PCI card for cooling said PCI card.

14. The system of claim 10, wherein power for powering said CPU cooling unit, computer case fans and said electronic controller is drawn via said PCI slot.

15. The system of claim 10, further comprising an additional temperature sensor located in said computer case and connected to said electronic controller, for monitoring temperature of air within the computer case.

16. The cooling system of claim 1, said computer having an internal power supply for providing power to said processor, and said cooling system being powered directly with power drawn from said internal power supply of the computer.

17. The cooling system of claim 9 wherein said dedicated power supply and said electronic controller are fabricated on a card which is mountable on a frame that fits into a standard 5¼″ or 3½″ drive bay.

18. The cooling system of claim 9, wherein said dedicated power supply and said electronic controller are mountable within the internal power supply of the computer.

19. The cooling system of claim 9, wherein said dedicated power supply and said electronic controller are mounted on a card which is mountable onto the TEC/heat sink assembly.

20. The cooling system of any of claim 1, further comprising a blue LED mounted so as to be viewable externally from the computer case, for providing an indication of active operation of the cooling system.

21. The cooling system according to claim 1, wherein said electronic controller maintains temperature of processor above dew-point.

22. The cooling system according to claim 1, wherein said processor may operate in various modes including sleep, idle and typical modes, and said electronic controller controls temperature of said processor in said sleep, idle and typical modes, whilst consuming only very low amounts of energy.

23. The cooling system according to claim 1, further comprising a duct fan having a speed controllable in accordance with temperature changes within said computer case.

24. A method for cooling processor of a computer, housed within a computer case, said computer being characterized by having low noise emission levels, the method comprising: mounting a processor-cooling unit in said computer case, the processor-cooling unit including: a thermoelectric component (TEC) couplable to mains for power supply; a cold side heat sink coupled to one side of said TEC and mounted to be in thermally conductive contact with the processor; a hot side heat sink coupled to the TEC on opposite side thereof to that of the cold side heat sink; a processor cooling fan directed onto the hot side heat sink, for convectively cooling said hot side heat sink; an electronic controller; and a processor temperature sensor coupled to said cold side heat sink for monitoring temperature of said processor, sensing the temperature of the processor and providing an indication thereof to the electronic controller, and varying the speed of said processor cooling fan in accordance with said sensed CPU temperature.

25. The method of claim 24, wherein the processor is a CPU.

26. The method of claim 24, wherein the electronic controller is a microprocessor.

27. The method of claim 24, further comprising: mounting at least one case fan within the computer case; mounting a temperature sensor within the computer case for monitoring ambient temperature therein; coupling said computer case temperature sensor to said electronic controller; sensing the ambient temperature inside the case and providing an indication thereof to said electronic controller; and varying the speeds of said processor cooling fan and said computer case fan via said electronic controller in accordance with said sensed processor temperature and said sensed ambient temperature, respectively.

28. The method according to claim 24, wherein said step of varying the speed of the processor cooling fan includes providing a pulse width modulated signal from the electronic controller via transistors, thus varying said fan speed using high efficiency pulse width modulation.

29. The method according to claim 24, further comprising: increasing processor cooling fan speed to a maximum speed in response to detecting a sudden increase in processor temperature via said processor temperature sensor.

30. The method according to claim 24, further comprising: sampling data from said processor temperature sensor; determining whether said sampled data is within a pre-selected acceptable range; and if said data is lower than said pre-selected range: get providing a Pulse Width Modulated signal output from said electronic controller to control power to said thermoelectric element; and reducing voltage across said processor cooling fan from 12V DC to 6V DC (or other pre-set voltage), thereby significantly reducing noise therefrom.

31. The method according to claim 27, further comprising applying a reduced voltage across said at least said one computer case fan, thus operating it at a reduced duty cycle and thereby reducing noise emitted therefrom.

32. The method according to claim 24, further comprising: sampling data from said CPU temperature sensor; determining whether said sampled data is within a pre-selected acceptable range; if said data is higher than said pre-selected range: setting a PWM signal output from said microprocessor to a maximum (about 100% PWM) thereby operating the thermoelectric element (s) at maximum power; and operating the processor fan at maximum speed for maximum cooling of the processor.

33. The method according to claim 32, further comprising operating computer case fans at about 100% of duty cycle.

34. The method according to claim 32, further comprising providing an indication that cooling is operating at maximum power.

35. The method according to claim 24, further comprising: sampling data from said CPU temperature sensor; determining whether said sampled data is within a pre-selected acceptable range over a lower threshold value; if said data is within said pre-selected range: varying a pulse wave modulated output from said electronic controller, in accordance with difference between the sampled data and the lower threshold value, so as to power the TEC according to the sampled data and maintain a stable processor temperature such that, if the processor temperature rises, the pulsed wave modulated signal is increased and more cooling power is provided thereby reducing the processor temperature, and if the processor temperature falls, the pulsed wave modulated signal is decreased and less cooling power is provided thereby allowing the processor temperature to rise.

36. The method according to claim 27, further comprising: sampling data from said CPU temperature sensor; determining whether said sampled data is within a pre-selected acceptable range over a lower threshold value; if said data is within said pre-selected range: varying a pulse wave modulated output from said electronic controller, in accordance with difference between the sampled data and the lower threshold value, so as to power the TEC according to the sampled data and maintain a stable processor temperature such that, if the processor temperature rises, the pulsed wave modulated signal is increased and more cooling power is provided thereby reducing the processor temperature, and if the processor temperature falls, the pulsed wave modulated signal is decreased and less cooling power is provided thereby allowing the processor temperature to rise, and applying an intermediate voltage across case fans of the computer so that said case fans run at an intermediate speed, correlating to about 66% duty cycle, thereby reducing noise emission levels from the computer, but providing adequate cooling to the processor thereof.

37. The method according to claim 24, further comprising: monitoring current temperature of the processor; periodically checking for sharp increases in processor temperature (dT/dt); such that if the current temperature is more than a predetermined amount higher than the temperature previously sampled, setting pulsed wave modulated signal output from said electronic controller to a maximum (100% PWM) to operate said thermoelectric element at maximum power; and operating the processor fan at maximum speed for maximum cooling with fast reaction time to prevent sharp increases in processor temperature.

38. The method according to claim 37, further comprising operating the computer case fan at about 66% of duty cycle.

39. (canceled)
